(19) United States
(12) Patent Application Publication
(10) Pub. No.: US 2024/0402728 A1
(43) Pub. Date: Dec. 5, 2024

(54) REAL-TIME PROXIMITY OPERATION AND OBJECT HANDOFF IN A RIDE/SHOW ENVIRONMENT

(71) Applicant: Universal City Studios LLC, Universal City, CA (US)

(72) Inventor: Eric A. Vance, Orlando, FL (US)

(21) Appl. No.: 18/642,486

(22) Filed: Apr. 22, 2024

Related U.S. Application Data
(60) Provisional application No. 63/506,330, filed on Jun. 5, 2023.

(51) Int. Cl. G05D 1/667; A63G 31/02; A63J 19/00; B25J 11/00; G05D 1/698; G05D 101/00; G05D 105/65

(52) U.S. Cl. CPC G05D 1/667; A63G 31/02; A63J 19/00; B25J 11/003; G05D 1/6987; G05D 2101/22; G05D 2105/65

(57) ABSTRACT

A show-ride system includes a first moveable component configured to couple with and support a show structure; a second moveable component configured to couple with and support the show structure; and a manipulator of the first moveable component, wherein the manipulator transfers the show structure from the first movable component to the second moveable component. The show-ride system also includes detection circuitry to determine an initial position of the first moveable component and an initial position of the second moveable component. The show-ride system also includes a positional controller configured to determine adjustments to the initial position of the first moveable component and/or the initial position of the second moveable component and provide instructions regarding the adjustments to the first moveable component and/or the second moveable component for a transfer of the show structure while the first moveable component, the second moveable component, or both are in motion.

### CROSS REFERENCE TO RELATED APPLICATIONS

This application claims benefit of U.S. Provisional Application Ser. No. 63/506,330, filed Jun. 5, 2022, entitled “REAL-TIME PROXIMITY OPERATION AND OBJECT HANDOFF IN A RIDE/SHOW ENVIRONMENT,” which is herein incorporated by reference in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Since the early twentieth century, amusement parks have substantially grown in popularity, and an increasing amount of people visit amusement park attractions. Further, an increasing number of amusement park attractions have utilized show-ride entertainment systems that provide various immersive experiences to guests within the amusement park. The show-ride entertainment systems may employ movable ride vehicles configured to receive and transport one or more of the guests within the amusement park. Further, the show-ride entertainment systems may generate visual, audio, and/or haptic feedback and may utilize various show structures (e.g., show action equipment) to provide an immersive experience to guests within the park. It is now recognized that it may be desirable to incorporate additional components into show-ride systems to provide additional services and features, thereby improving a guest experience within the amusement park.

### SUMMARY

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In an embodiment, a show-ride system includes a first moveable component configured to couple with and support a show structure and a second moveable component configured to couple with and support the show structure. The show-ride system also includes a manipulator of the first moveable component, where the manipulator is configured to transfer the show structure from a coupling with the first movable component into a coupling with the second moveable component. The show-ride system also includes detection circuitry configured to determine an initial position of the first moveable component and an initial position of the second moveable component and a positional controller configured to determine adjustments to the initial position of the first moveable component and/or the initial position of the second moveable component and provide instructions indicative of the adjustments to the first moveable component and/or the second moveable component for a transfer of the show structure from the first moveable component to the second moveable component while the first moveable component, the second moveable component, or both are in motion.

In an embodiment, a positional detection system includes one or more position data devices configured to communicate position data. The positional detection system also includes detection circuitry configured to receive position data to determine an initial position of a first moveable component and an initial position of a second moveable component. The positional detection system also includes a positional controller configured to determine adjustments to the initial position of the first moveable component and/or the initial position of the second moveable component and provide instructions indicative of the adjustments to the first moveable component and/or the second moveable component for a transfer of the show structure from the first moveable component to the second moveable component while the first moveable component, the second moveable component, or both are in motion. The positional detection system also includes one or more communication circuitry configured to enable communication among the positional controller, the first moveable component, and the second moveable component.

In an embodiment, a method of operating a show-ride system includes monitoring input data and receiving a transfer indication to transfer a show structure from a first moveable component to a second moveable component based on input data. The method also includes determining a position of the first moveable component and a position of a second moveable component based on position data received from one or more position data devices and determining the position of the first moveable component is within a positional envelope of the position of the second moveable component to enable the transfer of the show structure from the first moveable component to the second moveable component. The method also includes communicating transfer instructions to the first moveable component to initiate the transfer of the show structure from the first moveable component to the second moveable component and transferring the show structure from the first moveable component to a landing target on the second moveable component while the first moveable component, the second moveable component, or both are in motion, according to the transfer instructions.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and context of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an embodiment of a show-ride system of an amusement park, in accordance with present embodiments;

FIG. 2 is a schematic perspective view of various components of the show-ride system of FIG. 1, in accordance with present embodiments;

FIG. 3 is a schematic view of an embodiment of a show-ride system of an amusement park, in accordance with present embodiments;

FIG. 4 is a schematic block diagram of an embodiment of a show-ride system of an amusement park, in accordance with present embodiments; and

FIG. 5 is a flow diagram illustrating a method of operating a show-ride system, in accordance with present embodiments.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Further, to the extent that certain terms such as parallel, perpendicular, and so forth are used herein, it should be understood that these terms allow for certain deviations from a strict mathematical definition (as would be understood by one of ordinary skill in the art), for example to allow for deviations associated with manufacturing imperfections and associated tolerances.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure relates generally to the field of amusement parks and more specifically to show-ride entertainment systems within amusement parks. Show-ride entertainment systems may employ a number of different components to provide an experience for guests within an amusement park. For example, a show-ride entertainment system may include a show structure (e.g., a prop) mounted on a ride vehicle or another component of the show-ride entertainment system that is capable of being transferred from a ride vehicle to another component of the show-ride entertainment system. The show structure may include an active prop (e.g., an animated figure) or a static prop (e.g., a foam character) that is movable (e.g., capable of transfer between the ride vehicle and the other component of the show-ride entertainment system). It may be advantageous to enhance the guest experience by, for example, transferring the show structure from the ride vehicle to an animated figure of the entertainment system during a ride experience. To execute this transfer, the position, orientation, and velocity vector of the ride vehicle and the position, orientation, and velocity vector of the animated figure may be used. For ride vehicles and animated figures that have pre-programmed motion profiles, the respective position, orientation, and velocity vector of the ride vehicle and animated figure may be known and used to coordinate the transfer of the show structure from the ride vehicle to the animated figure (e.g., as part of a pre-programmed transfer routine) in accordance with present embodiments.

Show-ride systems in accordance with present embodiments may also benefit from having the ability to transfer a show structure (e.g., from a ride vehicle to an animated figure or vice versa) between a ride vehicle and animated figure, for which movement control is not performed according to a pre-programmed motion profile. A more spontaneous transfer (that is, where the ride vehicle and animated figure are capable of movement outside of a pre-programmed motion profile) may further enhance the guest experience by increasing the opportunities for the guests to spontaneously (e.g., in real-time) interact with the show-ride system and for the show-ride system to spontaneously interact with the guests. Accordingly, present embodiments include a show-ride system that includes a positional detection system and other components that enable a transfer of a show structure to and/or from a ride vehicle and other components (e.g., animated figures, other ride vehicles) of a show-ride system such that the transfer occurs from the ride vehicle, the motion of which is not according to a pre-programmed motion profile, to the animated figure, the motion of which is not according to a pre-programmed motion profile using a positional detection system. A transfer between a ride vehicle and an animated figure, the motions of which do not utilize a pre-programmed motion profile, may be referred to as a “real-time” transfer, which may provide more spontaneity and increase immersion for guests. The term “motion profile” as used with respect to the embodiments described herein refers to a series of movements, which have associated positional information. A motion profile may provide physical motion information of the moveable components and indicate how a motor controlling the motion of the moveable components should behave (often in terms of position, velocity, and acceleration) to generate the movement. The motion profile may be used by a controller to determine what commands (voltages) to send to the motor. Positional information can be obtained from the motion profile to guide interactions (e.g., provide coordinates of moving parts to facilitate interactions). However, this requires an established routine and takes away certain spontaneity (e.g., control by a guest). The term “pre-programmed motion profile” refers to a motion profile that is pre-programmed, or pre-determined, and does not include any elements that may be altered, for example, by user input or other input that is received by the controller while the moveable component is in motion or has begun the motion profile. Thus, certain sub-routines may be employed in a motion control algorithm without employing a pre-programmed motion profile.

The show-ride system may include one or more moveable components, which may be referred to as a mover and may be considered a component of the show-ride system that coordinates with other parts of the show-ride system. The moveable components may be, for example, show action equipment (e.g., animated figure, drone), one or more ride vehicles, or a combination thereof. One or more show structures (e.g., prop that can be moved about a ride environment for entertainment purposes) may be transferred from one moveable component to another moveable component. The first moveable component (e.g., show action equipment) may include a manipulator or other movement mechanism that may be configured to move the one or more show structures through the show-ride system (e.g., to the second moveable component). For example, the manipulator may operate to move the show structure to and from ride vehicles, to and from other show action equipment, and so forth. These interactions between movable components may provide unique and engaging experiences for guests of the show-ride system.

Ride vehicles in accordance with present embodiments may be configured to receive one or more guests within the amusement park and carry or transport the guests through a show-ride attraction. In some cases, the show structures may be positioned on a particular ride vehicle, and may be configured to operate (e.g., actuate features of an animated figure) to provide a show experience to guests within the ride vehicle. The ride vehicle may also include a manipulator or other movement mechanism configured to move the show structures through the show-ride system.

The moveable components (e.g., ride vehicles, show action equipment) may be on a predetermined path (e.g., a track, or trackless) or may be freely moveable within a defined show ride environment. Due to the moving nature of the various components within the show-ride system, it may be difficult to adjust a position of the first moveable component (e.g., the show action equipment) containing the show structure relative to the second moveable component (e.g., the ride vehicle or other show action equipment within the show-ride system) without interfering with a guest's experience.

To accomplish the transfer of the show structure from the first moveable component to the second moveable component, the two moveable components must be within a certain proximity of each other but also must not collide with each other. For a show-ride system that accomplishes the transfer between two movable components, the motion of which is according to a pre-programmed motion profile, the proximity of the two moveable components can be known, based on the pre-programmed motion profile. For a show-ride system that accomplishes the transfer between two movable components, the motion of which is not according to a pre-programmed motion profile, however, the real-time position, orientation, and velocity vector of the ride vehicle and the animated figure must be determined.

Thus, the show-ride system may also include a positional detection system to determine the relative proximity of the one or more moveable components to avoid collisions and determine the appropriate positioning for the transfer of the show structure. Accordingly, the positional detection system may receive position data regarding the positioning of the movable components (e.g., the position of the ride vehicle and the position of the show action equipment) and can direct the movement of the moveable components to be within a transfer proximity (e.g., a threshold distance or a positional envelope) allowing the show structure to be transferred from one of the moveable components (e.g., the show action equipment) to another moveable component (e.g., the ride vehicle). The appropriate positioning of the two moveable components for the transfer of the show structure may be closer than the known stopping distance (i.e., the distance needed to properly bring a vehicle to a complete stop) of one or more of the moveable components. Thus, the positional detection system may determine the position, orientation, and velocity vector of one of the moveable components and the position, orientation, and velocity vector of the other moveable component to determine the relative position, orientation, and velocity vector of the two moveable components and determine actions to be taken—by one or more of the moveable components—to avoid collision while the moveable components are within the transfer proximity or positional envelope. The show structure may be transferred while both of the moveable components are moving, while one of the moveable components is stationary, or while both of the moveable components are stationary.

The positional detection system may use position data devices such as cameras, light detection and ranging (LiDAR) sensors, sonar sensors, global positioning system (GPS) sensors, barcodes, or radio frequency identification (RFID) tags, or other technology to detect the position, orientation, and velocity vector of each moveable component. The positional detection system may include a positional controller for determining whether adjustment of the position, orientation, and velocity vector of each moveable component is necessary to accomplish the transfer. The positional controller may then provide instructions to each moveable component to adjust the position, orientation, and velocity vector as necessary to bring them within the positional envelope. The positional detection system thus communicates with communication circuitry on each moveable component to provide such instructions as input. The communication circuitry on each moveable component provides such input to the controller controlling the position, orientation, and velocity vector of each moveable component.

Upon receiving an indication to position the show structure on the second moveable component (e.g., the ride vehicle), based on input received from the positional detection system, the first moveable component (e.g., the show action equipment) and/or the second moveable component (e.g., the ride vehicle) may adjust their positions, orientations, and velocity vectors to be within the positional envelope. The manipulator on the first moveable component (e.g., show action equipment) may then position the show structure proximate a landing target of the second moveable component (e.g., ride vehicle). It should be understood that the manipulator may alternatively or additionally be located on the second moveable component. When the landing target of the second moveable component receives the show structure, the show-ride system may send a signal to the manipulator to disengage from the show structure. The landing target may include a connector or securement mechanism such as magnets, mechanical securement, or a combination thereof. Further, the show-ride system may determine, based on the coupling between the second moveable component and the show structure, to provide power (e.g., electrical power) and/or transfer entertainment data to the show structure from the second moveable component. The transfer of the show structure may be accomplished while one or more of the two moveable components are in motion.

Indeed, by utilizing the show-ride system discussed herein, the show structure may be transferred, transported, and/or manipulated more efficiently about the show-ride system while continuously operating to present entertainment data to guests, thereby providing an essentially seamless experience (e.g., experience with limited number of interruptions based on the show structure not receiving power and/or data) and interactive experience to guests transported through the show-ride system.

As may be appreciated, implementations of the present disclosure may be embodied as a system, method, device, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer-readable program code embodied thereon.

Computer program instructions, in accordance with present embodiments, may be stored in a computer readable medium (e.g., hard drive, memory, disk) that can direct a computer, other programmable data processing apparatus, or other devices to function in a particular manner, such that the instructions stored in the computer readable medium intimate or cause a specified function/act. The computer program instructions may also be loaded onto a computer, other programmable data processing apparatus, or other devices to cause a series of operational steps to be performed on the computer, other programmable apparatus or other devices to produce a computer implemented process such that the instructions, which execute on the computer or other programmable apparatus, provide processes for implementing the functions/acts specified in the flowchart and/or block diagram block or blocks.

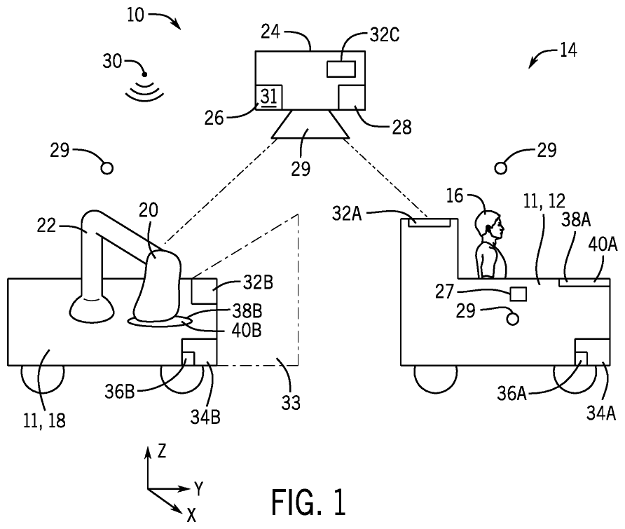

With the preceding in mind, FIG. 1 is a schematic view of a show-ride system 10, in accordance with embodiments discussed herein. As illustrated, the show-ride system 10 includes one or more moveable components 11 configured to move within an entertainment environment 14. Moveable components 11 may be referred to as movers and may be considered a component of the show-ride system 10 in that it coordinates with other parts of the show-ride system 10. As represented in the embodiment illustrated in FIG. 1, one moveable component 11 is a ride vehicle 12. The ride vehicle 12 may be configured to transport or carry guests 16 within the entertainment environment 14, thereby enabling the guests 16 to receive visual and/or audio feedback from components of the show-ride system 10 at different locations in the entertainment environment 14. The ride vehicle 12 may have a motion base with up to six degrees of freedom. The show-ride system 10 also includes a second moveable component 11, illustrated in FIG. 1 as show action equipment 18 (e.g., animated figure, drone), configured to provide visual, audio, and/or haptic feedback for guests 16 transported through the entertainment environment 14. The show action equipment 18 may have a motion base with up to six degrees of freedom. In some embodiments, the show action equipment 18 may include one or more show structure 20 (e.g., animated figures, characters, other objects) that interact with one another and/or with the ride vehicle 12 and/or with the show action equipment 18 to provide an immersive experience to the guests 16. For example, the show structure 20 may correspond to a transferable object (e.g., animated figure, character) that may be transferred by a manipulator 22 from the show action equipment 18 to the ride vehicle 12, for example, and may be operable to provide visual and/or audio feedback to the guests 16.

The show-ride system 10 may also include a positional detection system 24 that may be configured to determine spatial relationships between components of the show-ride system 10 in the entertainment environment 14, including moveable components 11. The positional detection system 24 receives position data regarding the positions of the moveable components 11 (e.g., a position of the ride vehicle 12 and a position of the show action equipment 18). That is, the positional detection system 24 receives position data regarding the position, orientation, and velocity vector of the ride vehicle 12 and the show action equipment 18. The position data may indicate that the ride vehicle 12 and the show action equipment 18 are each moving. That is, the position data may indicate an initial or first position, orientation, and velocity vector for the ride vehicle 12 and/or the show action equipment 18 and later indicate a different or second position, orientation, and velocity vector for the ride vehicle 12 and/or the show action equipment 18. The positional detection system 24 may instruct the movement of the ride vehicle 12 and the show action equipment 18 to cause the ride vehicle 12 and the show action equipment 18 to be within a positional envelope 33 (a distance within which the system is capable of transferring the show structure 20) allowing the show structure 20 to be transferred from the show action equipment 18 to the ride vehicle 12, as described in more detail below.

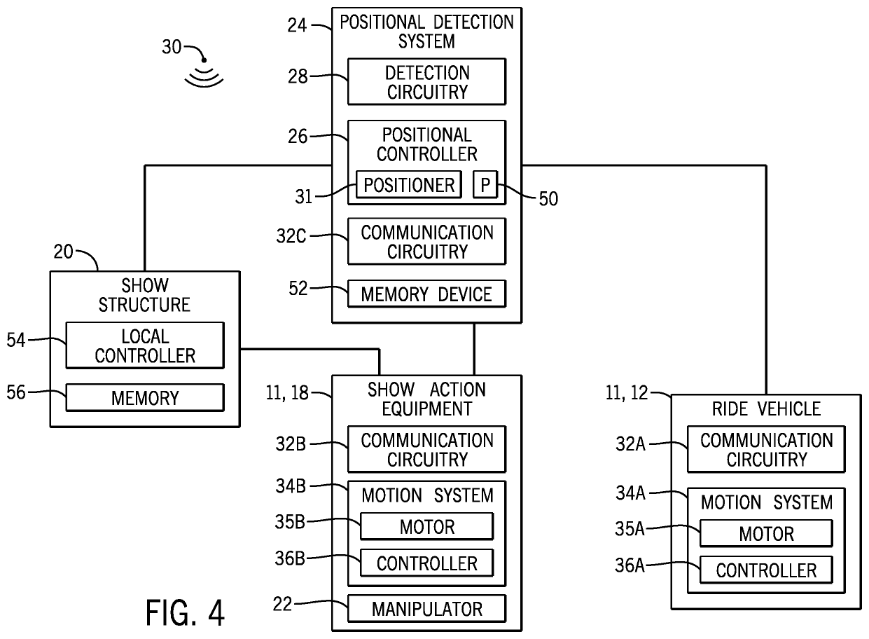

The positional detection system 24 includes a positional controller 26. The positional controller 26 may include processing circuitry 50 and one or more memory devices 52 (as shown in FIG. 4 and discussed in more detail below).

The positional detection system also includes detection circuitry 28. The positional controller 26 and/or the detection circuitry 28 may utilize position data devices 29 such as cameras, light detection and ranging (LiDAR) sensors, sonar sensors, global positioning system (GPS) sensors, barcodes, radio frequency identification (RFID) tags, coordinates, or other technology to detect the position, orientation, and velocity vector of each of the moveable components 11 (e.g., ride vehicle 12 and the show action equipment 18) of the show-ride system 10. Position data devices 29 could also include one or more proximity sensors on each moveable component 11, enabling the relative positioning of the moveable components 11 to be determined based on proximity data provided by the one or more proximity sensors.

For example, the positional controller and/or the detection circuitry 28 may utilize position data retrieved from one or more positional data device 29 such as cameras disposed about the entertainment environment 14 to determine the spatial relationships between the various components of the show-ride system 10. The one or more positional data device 29 may provide position data indicative of a position, orientation, and/or velocity vector of the ride vehicle 12, of the show structure 20, of the manipulator 22, of the show action equipment 18, or any combination thereof. The positional data device 29 as shown in FIG. 1 may represent multiple such positional data devices 29 in various locations in the entertainment environment 14.

The positional controller 26 may receive an indication from a control system or may generate an indication to provide instructions to transfer the show structure 20 from the show action equipment 18 to the ride vehicle 12. Using the position data, the positional controller 26 and/or the detection circuitry 28 may determine an expected position of a ride vehicle 12. The positional controller 26, or a separate controller, may monitor input data, which includes (1) the position data of one or more of the moveable components 11, e.g., data generated by a barcode reader onboard ride vehicle 12 that scanned an indicator in a zone of the entertainment environment 14, (2) interaction data, e.g., data generated by a guest 16 interacting with an input device 27 on ride vehicle 12 and/or (3) timing data, e.g., data from a separate controller regarding the location and timing of components of the show-ride system 10. The positional controller 26 may generate a transfer indication to provide instructions to transfer the show structure 20 from the show action equipment 18 to the ride vehicle 12 based on the input data that is monitored by the positional controller 26. The generation of the transfer indication may be triggered based on position data, for example when one or more positional data devices 29 indicate that the moveable components are within a positional envelope 33 or within a specific zone of the entertainment environment 14. The generation of the transfer indication may be triggered based on interaction data, for example when a guest interacts with an input device 27 that provides a trigger to generate a transfer indication. The generation of the transfer indication may be triggered based on timing data, for example based on the timing of certain events occurring within the entertainment environment 14. In some embodiments, the generation of the transfer indication may be triggered based on one or more of the aforementioned triggers, for example based on positional data and based on interaction data.

In some embodiments, a controller separate from the positional controller 26 may monitor the input data and generate the transfer indication based on input data to provide instructions to transfer the show structure 20 from one moveable component 11 to another moveable component 11 in the entertainment environment 14.

The positional envelope 33 is the zone within which the moveable components 11 may accomplish the transfer of the show structure 20 from one of the moveable components 11 (e.g., the show action equipment 18) to another moveable component 11 (e.g., the ride vehicle 12). The appropriate positioning of the two moveable components 11 for the transfer of the show structure 20 may be closer than the known stopping distance (i.e., the distance needed to properly bring a vehicle to a complete stop) of one or more of the moveable components 11. The positional envelope 33 may be determined based on established data (e.g., a reach of the manipulator 22) by the positional detection system 24, by a local controller 36A of the ride vehicle 12, by a local controller 36B of the show action equipment 18, or any other suitable system or processor. The positional envelope 33 may take into account multiple relationships with respect to relative positioning within three axes, x, y, and z.

The positional controller 26 may also be configured to determine whether the position, orientation, and velocity vectors of the moveable components 11 (e.g., show action equipment 18 and the ride vehicle 12) are appropriate to accomplish the transfer (e.g., whether the manipulator 22 is within the positional envelope 33 to transfer the show structure 20 from the show action equipment 18 to the ride vehicle 12). If the positional controller 26 determines that the position, orientation, and velocity vector of the moveable components 12, 18 are outside (e.g., not within) the positional envelope, based on the position data received, the positional controller 26 may provide instructions to the moveable components 11 (e.g., ride vehicle 12 and the show action equipment 18) to adjust their respective movements accordingly. Similarly, the positional controller 26 may instruct the manipulator 22 to retrieve the show structure 20 based on a determined expected position of the moveable component 11 (e.g., ride vehicle 12) that will be receiving the show structure 20. In this way, the moveable component 11 (e.g., show action equipment 18), including the manipulator 22, may be operated by the positional controller 26 based on the position data from the detection circuitry 28 to transport the show structure 20 about the show-ride system 10. As discussed above, the positional envelope 33 may include appropriate positioning of the two moveable components 11 for the transfer of the show structure 20 that is closer than the known stopping distance (i.e., the distance needed to properly bring a vehicle to a complete stop) of one or more of the moveable components 11. Thus, the positional detection system 24 may determine actions to be taken by one or more of the moveable components 11 to avoid collision while the moveable components 11 are within the positional envelope 33.

It should be understood that the positional controller 26 may include numerous features and/or numerous separate controllers working together. For example, operations related to determining position, orientation and velocity vectors and instructing movements accordingly may be performed by a positioner 31 (as shown, e.g., in FIG. 1 and FIG. 4) of the positional controller 26, which may share the same processing circuitry 50 with the positional controller 26, or may have a separate one or more processor.

In some embodiments, the moveable components 11 may form a communication connection with the positional detection system 24 using a communications system 30, for example, wireless communication paths via infra-red (IR) wireless communication, radio frequency transmission, Bluetooth, Wi-Fi, ultra-wideband (UWB) that enable communication between electronic devices over a distance, such as between four (4) meters (m) and twenty (20) meters. In some embodiments, the communications system 30 may be formed using a wired communications system, such as using fiber optic cables, Ethernet cables, telephone network cables, coaxial cables, twisted pair cables, or waveguide cables. The communications system 30 may thus include a wireless communications system (e.g., wireless network) or a wired communications system (e.g., a wired network).

The moveable components 11 may each include devices that enable communication between the positional detection system 24 and the moveable components 11. For example, one moveable component 11 (e.g., the ride vehicle 12) may include communication circuitry 32A such as a transmitter and/or a receiver, and another moveable component 11 (e.g., the show action equipment 18) may include communication circuitry 32B such as a transmitter and/or a receiver. The positional detection system 24 may include communication circuitry 32C such as a transmitter and/or a receiver. The communications system 30 may include communication circuitry 32A, 32B, and 32C.

For the remainder of the discussion of FIG. 1, the description may use ride vehicle 12 and show action equipment 18, as depicted in the embodiment illustrated in FIG. 1, but it should be appreciated that this description applies to one or more moveable components 11, which may be one or more ride vehicles, one or more show action equipment, or a combination thereof.

The communication circuitry 32A of the ride vehicle 12 may receive instructions from the communication circuitry 32C of the positional detection system 24 to adjust its position, orientation, and/or velocity vector based on input data received by the positional detection system 24. The instructions received from the communication circuitry 32C may be wirelessly transmitted instructions, that is instructions that are transmitted by the communication circuitry 32C over a wireless network. The communication circuitry 32A may provide the instructions to a motion system 34A of the ride vehicle 12 that controls the motion of the ride vehicle 12. The motion system 34A may include a controller 36A that instructs the motion system 34A to adjust the position, orientation, and/or trajectory of the ride vehicle 12 in accordance with the instructions received from the positional detection system 24. The motion system 34A may also include one or more motors 35A to carry out the appropriate motion of the ride vehicle 12. In embodiments where the ride vehicle 12 includes a manipulator 22, the motion system 34A of the ride vehicle 12 may also control the motion of the manipulator 22.

Similarly, the communication circuitry 32B of the show action equipment 18 may receive instructions from the communication circuitry 32C of the positional detection system 24 to adjust its position, orientation, and/or velocity vector based on input data received by the positional detection system 24. The instructions received from the communication circuitry 32C may be wirelessly transmitted instructions, that is instructions that are transmitted by the communication circuitry 32C over a wireless network. The communication circuitry 32B may provide the instructions to a motion system 34B of the show action equipment 18 that controls the motion of the show action equipment 18, including the motion of the manipulator 22 for embodiments in which the show action equipment 18 includes the manipulator 22. The motion system 34B may include a controller 36B that instructs the motion system 34B to adjust the position, orientation, and/or velocity vector of the show action equipment 18 and/or of the manipulator 22, in accordance with the instructions received from the positional detection system 24. The motion system 34B may also include one or more motors 35B to carry out the appropriate motion of the show action equipment 18 and/or the manipulator 22.

After the show action equipment 18 and the ride vehicle 12 are within the positional envelope 33, which may require one or both of the show action equipment 18 and the ride vehicle 12 moving from respective initial positions, the transfer of the show structure 20 from the show action equipment 18 to the ride vehicle 12 may be initiated, as described in more detail below.

The manipulator 22 may correspond to one moveable component 11 (e.g. show action equipment 18 in the embodiment illustrated in FIG. 1) configured to transfer the show structure 20 to a particular location within the show-ride system 10 (e.g., from a show action equipment 18 to a ride vehicle 12, from a ride vehicle 12 to the show action equipment 18, from a first ride vehicle 12 to a second ride vehicle 12). In some embodiments, the manipulator 22 may include arms and/or joints that enable the manipulator 22 to transport the show structure 20 about the show-ride system 10 with multiple degrees of freedom. The manipulator 22 may include a number of arms and a number of joints configured to facilitate manipulation or movement of the show structure 20 with multiple (e.g., six) degrees of freedom. Indeed, the manipulator 22 may move the show structure 20 with any suitable quantity of degree(s) of freedom, such as 1, 2, 3, 4, 5, or 6 degrees of freedom.

Additionally, the arms and joints may enable the manipulator 22 to adjust a position and/or orientation of the show structure 20, thereby facilitating transfer and coupling with and/or securement of the show structure 20 with/to the moveable component 11 and transfer of the show structure 20 from one moveable component 11 to another moveable component 11, for example, between the ride vehicles 12, the manipulator 22, and the show action equipment 18, as described in greater detail below. Again, the show-ride system 10 may include one or more manipulators 22 and the manipulator 22 may be disposed upon the ride vehicle 12 in the alternative, or in addition to, being disposed upon the show action equipment 18.

Further, as discussed above, the positional controller 26 (e.g., an electronic and/or processor-based controller, automation controller, control system) may be utilized to control operation of the manipulator 22. For example, the positional controller 26 may control the position and movements of the arms and the joints of the manipulator 22 to adjust a position of the show structure 20 based on expected locations of the various components within the show-ride system 10. In some embodiments, the positional controller 26 may utilize the positioner 31 to determine expected locations of various components within the show-ride system 10, thereby enabling the positional controller 26 to control a position of the manipulator 22 accordingly.

As an example and as shown in the embodiment illustrated in FIG. 1, the show structure 20 may be transferred by the manipulator 22 from a landing target 38B on the show action equipment 18 to a landing target 38A on the ride vehicle 12 according to transfer instructions received from the positioner controller 26 or a separate controller. The transfer instructions may include instructions to engage the manipulator 22 with the show structure 20 while the show structure 20 is on the landing target 38B of the show action equipment 18, move the manipulator 22 to position the show structure 20 onto the landing target 38A of the ride vehicle 12, and then disengage the manipulator 22 from the show structure 20 after the show structure 20 has engaged with the landing target 38A on the ride vehicle 12.

The landing target 38A may be a receptacle configured to receive and electrically couple with a connector of the ride vehicle 12. Landing target 38A may include a connector and more specifically include a securement mechanism 40A (e.g., an electromagnet, an electrical connection hook/loop fabric) that secures the show structure 20 onto the ride vehicle 12. The landing target 38B on the show action equipment 18 may be a receptacle configured to receive and electrically couple with a connector of the show action equipment 18. The landing target 38B may include a connector and may include a securement mechanism 40B (e.g., an electromagnet, an electrical connection, hook/loop fabric), that secures the show structure 20 onto the show action equipment 18 as shown in the embodiment illustrated in FIG. 1.

Thus, the transfer instructions may include instructions for the show action equipment 18 and/or the manipulator 22 to disengage the show structure 20 from the landing target 38B on the show action equipment 18 by disengaging the securement mechanism 40B, moving the manipulator 22 to position the show structure 20 onto the landing target 38A of the ride vehicle 12, and disengaging the manipulator 22 from the show structure 20 after the show structure 20 has been secured onto the landing target 38A of the ride vehicle 12 via the securement mechanism 40A.

Because the input data is monitored and the transfer occurs between moveable components 11 that have a freeform motion profile, and not according to a pre-programmed motion profile, the transfer of the show structure 20 is essentially occurring in real-time. As a result, one or more moveable components 11 can continue to move and adjust during the transfer, which adds options for creating effects that are engaging and immersive for the guests. As discussed above, the positional detection system 24 may determine actions to be taken by one or more of the moveable components 11 to avoid collision while the moveable components 11 are within the positional envelope 33.

In some embodiments, the show structure 20 may operate based on power (e.g., electrical power) and entertainment data received from a component of the show-ride system 10. For example, upon coupling with a particular ride vehicle 12, the manipulator 22, or the show structure 20 may receive power and entertainment data, thereby enabling the show structure 20 to operate and present to the guests 16 based on the entertainment data. Further, the show structure 20 may be actuated while coupled to the ride vehicle 12 to make it appear to be alive. For example, during operation, aspects of the show structure 20 may be mechanically moved (e.g., moving an appendage, moving an arm, moving a leg, moving a body part), entertainment data may be displayed via an electronic display associated with the show structure 20, audio data may be output from a speaker associated with the show structure 20, aspects of the show structure 20 may be illuminated (e.g., eyes light up), or any combination thereof. Upon providing an experience (e.g., movement of the show structure 20 on the ride vehicle 12, audio and/or light emission from the show structure 20) to the guests 16 within the particular ride vehicle 12, the manipulator 22 on the show action equipment 18 may retrieve the show structure 20 (e.g., couple with the show structure 20 and simulate the show structure 20 leaving the ride vehicle 12) and, after being positioned appropriately with a different ride vehicle 12 as described above, place the show structure 20 on the different ride vehicle 12 such that additional ride vehicles 12 in the entertainment environment 14 may receive visual and/or audio feedback from the show structure 20. This may be done in a manner that conceals the nature of the transfer.

Further, while the manipulator 22 is illustrated as a movement mechanism having one or more arms and one or more joints, in some embodiments, the manipulator 22 may also be configured to provide guests with an experience. That is, in some embodiments, the manipulator 22 may also operate to provide visual and/or audio feedback to guests on the show-ride system 10 regardless of whether the show structure 20 is coupled to the manipulator 22.

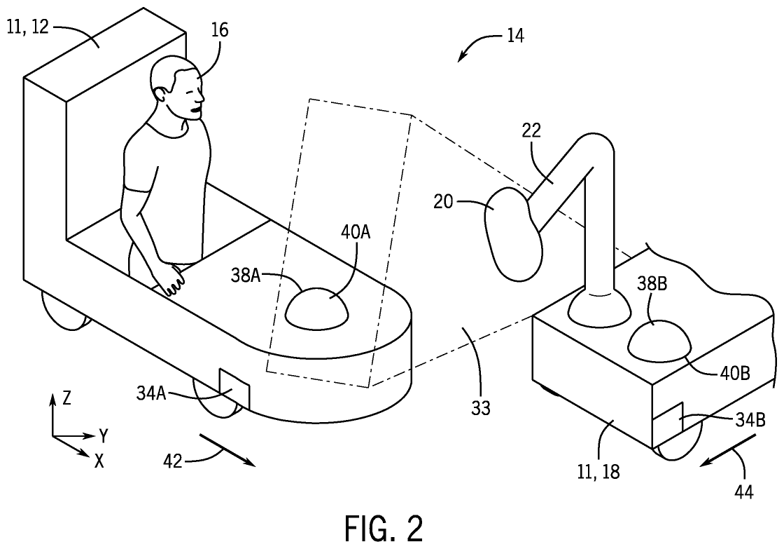

FIG. 2 is a schematic perspective view of components of a show-ride system 10, in accordance with embodiments discussed herein. As depicted in the embodiment illustrated in FIG. 2, the moveable components 11 include the ride vehicle 12 and the show action equipment 18. The ride vehicle 12 is in motion in a direction 42 and the show action equipment 18 is in motion in a direction 44. As illustrated in FIG. 2, the position, orientation, and velocity vector of both the ride vehicle 12 and the show action equipment 18 is in accordance with instructions received from the positional detection system 24 (e.g., the positioner 31) based on input data. The instructions from the positional detection system 24 are executed by the motion system 34A of the ride vehicle 12 and executed by the motion system 34B of the show action equipment 18 to bring the ride vehicle 12 into the positional envelope 33, such that the show structure 20 may be transferred by the manipulator 22 from the show action equipment 18 to the ride vehicle 12, and more particularly to the landing target 38A on the ride vehicle 12. As discussed above, the positional envelope 33 may be determined based on established data (e.g., a reach of the manipulator 22) by the positional detection system 24, by the local controller 36A of the ride vehicle 12, by the local controller 36B of the show action equipment 18 as shown in FIG. 1, or any other suitable system or processor. The positional envelope 33 may take into account multiple relationships with respect to relative positioning within three axes, x, y, and z.

Notably, in one embodiment, the positional detection system 24 allows the show action equipment 18 to come into a proximity of the ride vehicle 12 that is closer than the stopping distance of either the ride vehicle 12 or the show action equipment 18. That is, the positional envelope 33 may be less than the stopping distance of either the ride vehicle 12 or the show action equipment 18. This is accomplished by the positional detection system 24 controlling the motion system 34A of the ride vehicle 12 and the motion system 34B of the show action equipment 18, which allows for movement adjustments to accommodate stopping. By allowing this, present embodiments can contribute to a more immersive and enjoyable experience for the guests 16 because active positioning within a threshold defined by the stopping distance allows for engagement at higher speeds and in closer proximity.

In addition, the positional detection system 24, as shown in FIG. 1, allows for transfer of the show structure 20 in real-time and does not depend on the ride vehicle 12 or the show action equipment 18 traveling according to a pre-programmed motion profile (e.g., on a pre-defined path at a pre-defined speed). The ride vehicle 12, the show action equipment 18, or both may have a motion profile that is not pre-programmed, e.g., a “freeform motion profile,” that is on a freeform path and at a freeform speed, within the entertainment environment 14. The freeform path may be controlled, in whole or in part, by the guest 16 or other external factors. The ride vehicle 12 may be traveling at a freeform speed, which may be within a range of acceptable speeds, that may be controlled, in whole or in part, by the guest 16 or other external factors. Because of the positional detection system 24, the position, orientation, and velocity vector of each of the ride vehicle 12 and the show action equipment 18 may be detected and thus the relative positioning of the ride vehicle 12 and the show action equipment 18 may be determined to verify that the ride vehicle 12 and the show action equipment 18 are each within the positional envelope 33, such that the transfer of the show structure 20 may be accomplished even when the ride vehicle 12, the show action equipment 18, or both have a motion profile that is not pre-programmed in the entertainment environment 14.

While the examples provided in this disclosure focus on the transfer of the show structure 20 from the show action equipment 18 to the ride vehicle 12, it should be appreciated that the present disclosure also encompasses the transfer of the show structure 20 from one moveable component 11 to a second moveable component 11, for example from a first show action equipment 18 to a second show action equipment 18, from a first ride vehicle 12 to a second ride vehicle 12, from a ride vehicle 12 to a show action equipment 18, or any combination thereof.

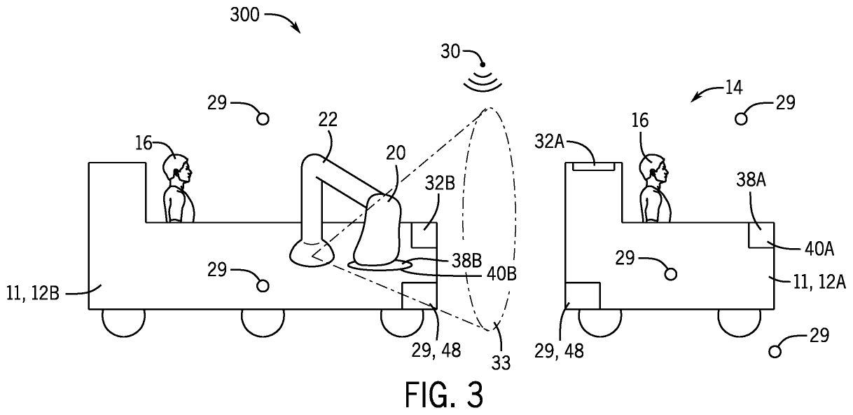

FIG. 3 is a schematic view of another embodiment of a show-ride system 300, in accordance with embodiments discussed herein. In FIG. 3, components of the positional detection system 24 are disposed on the moveable components 11, illustrated as a first ride vehicle 12A and a second ride vehicle 12B. For example, as an alternative to or in addition to one or more positional data devices 29 disposed about the show-ride system 10, the position data may be supplied by one or more positional data device 29 located on the first ride vehicle 12A itself. For example, the first and second ride vehicles 12A, 12B may each include one or more inertial measurement unit (IMU) sensors 48 as one of the positional data devices 29. The IMU sensor 48 may include gyroscopes to measure and report angular rate, accelerometers to measure and report specific force and/or magnetometers to measure the magnetic field surrounding the first ride vehicle 12A, for example, as a way of detecting the orientation and velocity vector of first ride vehicle 12A, like a compass. A signal from an accelerometer of the IMU sensor 48 may be used as position data to identify the position, orientation, and velocity vector of the first ride vehicle 12A or the second ride vehicle 12B. Similarly, the second ride vehicle 12B may also provide position data regarding its position, orientation, and velocity vector to the positional detection system 24 based on one or more of the positional data devices 29 (for example, an IMU sensor 48) located on the second ride vehicle 12B. In some embodiments, the positional data device 29 may include proximity sensors enabling the relative positioning of the moveable components 11 to be determined based on proximity data provided by the one or more proximity sensors. The positional controller 26 may use such proximity data from the one or more proximity sensors to control the transfer of the show structure 20.

As described with respect to FIG. 1, the detection circuitry 28 of the positional detection system 24 may receive position data from the first ride vehicle 12A and position data from the second ride vehicle 12B. The position data may be sent by the communication circuitry 28A of the first ride vehicle 12A and the communication circuitry 28B of the second ride vehicle 12B over the communications system 30, to detection circuitry 28, as described with respect to FIG. 1. The positioner 31 then may determine whether the position, orientation, and velocity vectors of both the first ride vehicle 12A and the second ride vehicle 12B are appropriate to accomplish the transfer (e.g., whether the manipulator 22 is within the positional envelope 22 to transfer the show structure 20 to the second ride vehicle 12B). If the positioner 31 determines that the position, orientation, and velocity vector of the first ride vehicle 12A and the second ride vehicle 12B are not within the positional envelope 33, based on the position data received, the positioner 31 may provide instructions to the first ride vehicle 12A and the second ride vehicle 12B to adjust their movements accordingly to bring them within the positional envelope 33. Similarly, the positioner 31 may instruct the manipulator 22 to retrieve the show structure 20 based on a determined expected position of the ride vehicle 12 to which the show structure 20 may be transferred. In this way, the manipulator 22, the first ride vehicle 12A, and the second ride vehicle 12B may be operated by the positioner 31 based on the position data from the detection circuitry 28 to transport the show structure 20 about the show-ride system 10.

FIG. 4 is a schematic block diagram of an embodiment of the show-ride system 10, in accordance with present embodiments. FIG. 4 illustrates some of the components of the show-ride system 10 in more detail. In some embodiments, certain components of the show-ride system 10 discussed above (e.g., moveable components 11, show structure 20, manipulator 22) may be communicatively coupled to the positional controller 26, which is configured to control operation of the show-ride system 10. The positional controller 26 may include a distributed control system or any computer-based system that is fully or partially automated. For example, the positional controller 26 may include processing circuitry 50 (e.g., a microprocessor(s)) that may execute instructions (e.g., software programs, algorithms, executable code) to perform the disclosed techniques. Moreover, the processing circuitry 50 may include multiple microprocessors, one or more “general-purpose”microprocessors, one or more special-purpose microprocessors, and/or one or more application specific integrated circuits (ASICs), or some combination thereof.

The positional detection system 24 may include a memory device 52 for storing instructions executable by the processing circuitry 50. Data stored on the memory device 52 may include, but is not limited to, algorithms for operation of the ride vehicle 12, the show structure 20, the manipulator 22, and/or the show action equipment 18. For example, in some embodiments, the memory device 52 may store information regarding the components of the show-ride system 10, including the moveable components 11 (e.g., ride vehicle 12, show action equipment 18), the manipulator 22, and the show structure 20, such as algorithms regarding altering the position, orientation, and velocity vector of the moveable components 11 to accomplish the transfer of the show structure 20.

The positioner 31 may determine, based on these algorithms, that the position, orientation, and/or velocity vector of the show action equipment 18, the ride vehicle 12, the manipulator 22, or a combination thereof may need to be adjusted and may issue instructions to make such adjustments. The communication circuitry 32C of the positional detection system 24 may communicate the instructions from the positioner 31 to the ride vehicle 12, the manipulator 22, and/or the show action equipment 18. The instructions are received by the communication circuitry 32A on the ride vehicle 12, the communication circuitry 32B on the show action equipment 18 (including the manipulator 22), and provided to the local controllers 36A and 36B, respectively. The local controllers 36A and 36B then provide instructions to the motion systems, 34A and 34B, respectively, to adjust the motion of the ride vehicle 12, the show action equipment 18, the manipulator 22, as applicable. As another example, data stored on the memory device 52 may include, but is not limited to, information regarding the theme of the show-ride system 10 and whether a particular piece of show structure 20 is appropriate to transfer from the show action equipment 18 to the ride vehicle 12 (e.g., whether the show structure 20 is a part of the theme or experience of the ride vehicle 12). The memory device 52 may be integrated with the positional controller 26 or, as shown in the embodiment illustrated in FIG. 4, separate from the positional controller 26.

As another example, in some embodiments, the memory device 52 may store the entertainment data used to operate the show structure 20, and the communication circuitry 32C of the positional detection system 24 may communicate the entertainment data to the ride vehicle 12, the manipulator 22, and/or the show action equipment 18. In turn, upon the show structure 20 coupling with the ride vehicle 12, the manipulator 22, and/or the show action equipment 18, the entertainment data communicated via the positional controller 26 may be transferred to the show structure 20, thereby enabling operation of the show structure 20 from the respective coupling location, or landing target 38B. In some embodiments, entertainment data stored on the memory device 52 may be sent directly to a local controller 54 associated with the show structure 20, thereby enabling the show structure 20 to operate to present the entertainment data. Further, in some embodiments, the show structure 20 may store the entertainment data locally, and upon receiving power (e.g., via a coupling with the ride vehicle 12, the manipulator 22, the show action equipment 18), the show structure 20 may operate to present the entertainment data to the guests 16.

In some embodiments, the local controller 54 of the show structure 20 may include local memory 56 to store the entertainment data needed to operate the show structure 20, and the show structure 20 may present the entertainment data stored on the local memory 56 to the local controller 54. Further, as noted above, in some embodiments, the show structure 20 may also include a local power source (e.g., battery) that enables the show structure 20 to operate regardless of whether coupled to a separate power supply (e.g., an electrical coupling with the ride vehicle 12, the manipulator 22, and/or the show action equipment 18).

As noted above, in some embodiments, the ride vehicle 12 also includes the motion system 34A that includes the motor 35A and the local controller 36A (e.g., processor-based controller). In some embodiments, the show action equipment 18 also includes the motion system 34B that includes the motor 35B and the local controller 36B (e.g., processor-based controller). As described above, the positional controller 26 may be communicatively coupled with the local controllers 36A and 36B and may send control signals to the local controllers 36A and 36B to operate the motion system 34A of the ride vehicle 12 and/or the motion system 34B of the show action equipment 18, thereby enabling the ride vehicle 12 to be within the appropriate transfer proximity 46 of the show action equipment 18 to allow the transfer of the show structure 20.

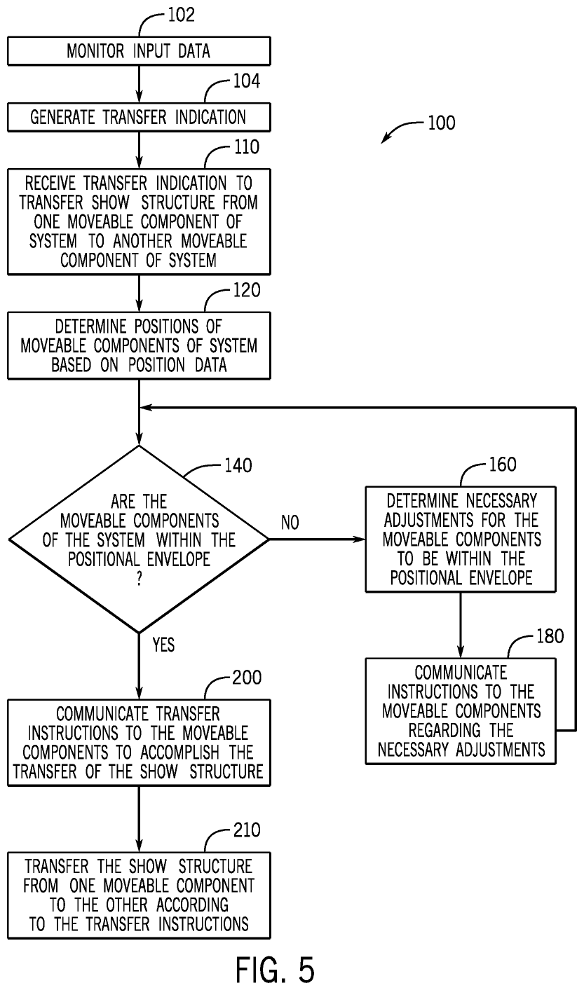

FIG. 5 is a flow diagram illustrating one embodiment of a method 100 of operating the show-ride system 10, in accordance with present techniques. It is to be understood that the steps discussed herein are merely exemplary, and certain steps may be omitted or added, and the steps may be performed in a different order. In one embodiment, the steps of the method 100 may be executed by the show-ride system 10.

The method 100 includes a step of monitoring input data (block 102). As discussed above, the positional controller 26 or a separate controller may monitor input data, which includes (1) the position data of one or more of the moveable components 11, (2) interaction data, for example, data generated by a guest 16 interacting with an input device, (3) timing data, for example, data from a separate controller regarding the location and timing of components of the show-ride system 100, and/or (4) location/orientation data, for example data generated by a barcode reader onboard ride vehicle 12 that scanned an indicator in a zone of the entertainment environment 14.

The method also includes a step of generating a transfer indication, that is an indication to provide instructions to transfer the show structure 20 from the show action equipment 18 to the ride vehicle 12 based on the input data that is monitored (block 104). The positional controller 26 or a separate controller may generate the transfer indication. As discussed above, the transfer indication may be generated in response to a trigger, such as when multiple positional data devices 29 within the entertainment environment 14 indicate that the moveable components 11 are within the positional envelope 33. The trigger may also be based on an input from a guest received from the input device 27.

The method also includes receiving the transfer indication to transfer show structure 20 from one moveable component 11 of the show-ride system 10 (e.g., the show action equipment 18) to another moveable component 11 of the show-ride system 10 (e.g., the ride vehicle 12) (block 110). The method also includes the step of determining the positions of the moveable components 11 of the show-ride system 10 (block 120). As described above, determining the positions of the moveable components 11 may include the positional controller 26 and/or the detection circuitry 28 receiving position data from one or more position data devices 29 such as cameras, LiDAR (light detection and ranging) sensors, sonar sensors, GPS (global positioning system) sensors, barcodes, radio frequency identification (RFID) tags, coordinates, and the like, or other technology to detect the position, orientation, and velocity vector of each moveable component 11.

The method also includes a step of determining whether the movable components 11 are within the positional envelope 33 necessary to accomplish the transfer of the show structure 20 from one moveable component 11 with the show structure 20 to another moveable component 11 (block 140). As described above, the determination whether the moveable components 11 are within the positional envelope 33 may be performed by the positional detection system 24, or more specifically the positional controller 26, or even more specifically, the positioner 31. If the moveable components 11 are outside the positional envelope 33 (e.g., not within the positional envelope 33), the method proceeds to determine the necessary adjustments for the moveable components 11 to be within the positional envelope 33 (block 160). As described above, the positioner 31 may determine the necessary adjustments. The method also includes a step of communicating instructions regarding the adjustments to the moveable components 11 (block 180). As described above, the positioner 31 may communicate the instructions regarding the adjustments via the communication circuitry 32C to the communication circuitry 32A and 32B on the moveable components 11. The motion systems 34A and 34B of the movable components 11 then execute the instructions. The method proceeds back to block 140 to determine whether the moveable components are within the positional envelope 33 to accomplish the transfer of the show structure 20.

If the moveable components are within the positional envelope 33 to accomplish the transfer of the show structure 20, the method proceeds to communicate transfer instructions to the moveable components to accomplish the transfer of the show structure 20 (block 200). As described above, the positional detection system 24 may communicate the transfer instructions via the communication circuitry 32C to the communication circuitry 32A and 32B on the moveable components 11.

The method also includes the step of transferring the show structure 20 from one moveable component 11 to the other moveable component 11 according to the transfer instructions (block 210). The transfer may occur while both moveable components 11 are in motion, while neither moveable component 11 is in motion, or while one of the moveable components 11 are in motion. Because the input data is monitored and the transfer occurs between moveable components 11 that are not moving according to a pre-programmed motion profile, and thus the transfer is occurring essentially in real-time, one or more moveable components 11 can continue to move and adjust during the transfer, which adds options for creating effects that are engaging and immersive for the guests.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

While only certain features of disclosed embodiments have been illustrated and described herein, many modifications and changes will occur to those skilled in the art. It is, therefore, to be understood that the appended claims are intended to cover all such modifications and changes as fall within the true spirit of the present disclosure.

1. A show-ride system, comprising:
a first moveable component configured to couple with and support a show structure;
a second moveable component configured to couple with and support the show structure;
a manipulator of the first moveable component, wherein the manipulator is configured to transfer the show structure from a coupling with the first movable component into a coupling with the second moveable component;
detection circuitry configured to determine an initial position of the first moveable component and an initial position of the second moveable component; and
a positional controller configured to determine adjustments to the initial position of the first moveable component and/or the initial position of the second moveable component and provide instructions indicative of the adjustments to the first moveable component and/or the second moveable component for a transfer of the show structure from the first moveable component to the second moveable component while the first moveable component, the second moveable component, or both are in motion.

2. The show-ride system of claim 1, comprising:
a positional detection system separate from the first moveable component and the second moveable component, wherein the positional detection system includes at least a camera, light detection and ranging (LiDAR) sensor, sonar sensor, global positioning system (GPS) sensor, barcode, or radio frequency identification (RFID) tag configured to communicate position data of the first moveable component and the second moveable component to the detection circuitry, and the positional detection system includes the positional controller, and the positional controller includes the detection circuitry.

3. The show-ride system of claim 1, comprising proximity sensors configured to detect relative positioning of the first moveable component and the second movable component with respect to each other, wherein the positional controller is configured to use proximity data from the proximity sensor to control the transfer of the show structure from the first moveable component to the second moveable component.

4. The show-ride system of claim 1, wherein the first moveable component has a first motion profile and the second moveable component has a second motion profile, and wherein the first motion profile is not pre-programmed and the second motion profile is not pre-programmed.

5. The show-ride system of claim 1, wherein the first moveable component comprises show action equipment and the second moveable component comprises a ride vehicle.

6. The show-ride system of claim 1, wherein the second moveable component comprises a receptacle configured to receive and electrically couple with a connector of the show structure.

7. The show-ride system of claim 1, comprising at least a camera, light detection and ranging (LiDAR) sensor, sonar sensor, global positioning system (GPS) sensor, barcode, or radio frequency identification (RFID) tag, configured to communicate position data of the first moveable component and the second moveable component to the detection circuitry, and the positional controller includes the detection circuitry.

8. The show-ride system of claim 1, comprising the show structure, wherein the show structure comprises an animated figure configured to receive electrical power from the first moveable component, the second moveable component, or both.

9. The show-ride system of claim 1, wherein the first moveable component comprises a motion system and a local controller configured to provide instructions to the motion system to adjust the motion of the first moveable component, including the motion of the manipulator.

10. The show-ride system of claim 1, wherein:
the first moveable component comprises first communication circuitry configured to receive wirelessly transmitted instructions from the positional detection system; and
the second moveable component comprises second communication circuitry configured to receive wirelessly transmitted instructions from the positional controller.

11. The show-ride system of claim 1, wherein the positional controller is configured to provide transfer instructions to the first moveable component to enable the transfer of the show structure from the first moveable component to the second moveable component.

12. A positional detection system comprising:
one or more position data devices configured to communicate position data;
detection circuitry configured to receive position data to determine an initial position of a first moveable component and an initial position of a second moveable component;
a positional controller configured to determine adjustments to the initial position of the first moveable component and/or the initial position of the second moveable component and provide instructions indicative of the adjustments to the first moveable component and/or the second moveable component for a transfer of the show structure from the first moveable component to the second moveable component while the first moveable component, the second moveable component, or both are in motion; and
one or more communication circuitry configured to enable communication among the positional controller, the first moveable component, and the second moveable component.

13. The positional detection system of claim 12, wherein the one or more position data devices comprise at least a camera, light detection and ranging (LiDAR) sensor, sonar sensor, global positioning system (GPS) sensor, barcode, or radio frequency identification (RFID) tag.

14. The positional detection system of claim 12, wherein the positional controller comprises a positioner configured to provide instructions to the first moveable component to cause an adjusted position of the first movable component to be within a positional envelope relative to a second position of the second movable component to enable the transfer of the show structure from the first moveable component to the second moveable component.

15. The positional detection system of claim 12, wherein the positional controller does not operate based on a pre-programmed motion profile.

16. The positional detection system of claim 12, wherein one or more elements of the positional detection system are disposed on the first moveable component and one or more elements of the positional detection system are disposed on the second moveable component.

17. A method of operating a show-ride system, the method comprising:
monitoring input data;
receiving a transfer indication to transfer a show structure from a first moveable component to a second moveable component based on input data;
determining a position of the first moveable component and a position of a second moveable component based on position data received from one or more position data devices;
determining the position of the first moveable component is within a positional envelope of the position of the second moveable component to enable the transfer of the show structure from the first moveable component to the second moveable component;
communicating transfer instructions to the first moveable component to initiate the transfer of the show structure from the first moveable component to the second moveable component; and
transferring the show structure from the first moveable component to a landing target on the second moveable component while the first moveable component, the second moveable component, or both are in motion, according to the transfer instructions.

18. The method of claim 17, comprising:
determining the first moveable component is outside the positional envelope of the second moveable component;
determining one or more adjustments for the position of the first moveable component and/or the position of the second moveable component; and
communicating instructions regarding the adjustments to at least the first moveable component or the second moveable component.

19. The method of claim 17 wherein the transfer indication is based on the input data and wherein the input data comprises position data, interaction data, timing data, or a combination thereof.

20. The method of claim 17, wherein the communicating instructions to the first moveable component comprises communicating instructions to communication circuitry of the first moveable component.
